(19) United States
(12) Patent Application Publication
(10) Pub. No.: US 2024/0242095 A1
(43) Pub. Date: Jul. 18, 2024

(54) ARTIFICIAL INTELLIGENCE DEVICE FOR MULTI-PURPOSE RETRIEVAL FOR KNOWLEDGE BASE QUESTION AND ANSWERING AND CONTROL METHOD THEREOF

(71) Applicant: LG ELECTRONICS INC., Seoul (KR)

(72) Inventors: Manasa BHARADWAJ, Toronto (CA); Yipeng JI, Toronto (CA); Yolanda LIU, Toronto (CA); Borislav MAVRIN, Alberta (CA)

(73) Assignee: LG ELECTRONICS INC., Seoul (KR)

(21) Appl. No.: 18/416,163

(22) Filed: Jan. 18, 2024

Related U.S. Application Data
(60) Provisional application No. 63/439,617, filed on Jan. 18, 2023.

(51) Int. Cl. G06N 5/022

(52) U.S. Cl. CPC G06N 5/022

(57) ABSTRACT

A method for controlling an artificial intelligence (AI) device can include obtaining, via a processor in the AI device, a knowledge base including a plurality of nodes, and flattening, via the processor, the knowledge base by transforming the knowledge base into a first plurality of documents to form a first index, each of the first plurality of documents identifying a node within the knowledge base. Also, the method can further include receiving, via the processor, a user query, retrieving, via the processor, a subset of documents based on the first plurality of documents and the user query, and performing, via the processor, a task related to knowledge base question answering (KBQA) based on the subset of documents.

### CROSS-REFERENCE TO RELATED APPLICATIONS

This non-provisional application claims priority under 35 U.S.C. § 119(c) to U.S. Provisional Application No. 63/439,617, filed on Jan. 18, 2023, the entirety of which is hereby expressly incorporated by reference into the present application.

### BACKGROUND

### Field

The present disclosure relates to a device and method for fast and robust multi-purpose retrieval for knowledge base question and answering (KBQA), in the field of artificial intelligence (AI). Particularly, the method can quickly and accurately retrieve documents and efficiently perform related tasks for knowledge base question and answering, in the AI field.

### Discussion of the Related Art

Knowledge base question and answering (KBQA) systems and applications have gained significant traction in recent years, driven by the growing need to access and synthesize relevant knowledge efficiently. While traditional search engines excel at finding documents, they often struggle to provide accurate and concise answers to specific questions, leaving users wading through mountains of potentially irrelevant information.

Knowledge base question and answering (KBQA) systems and applications present a paradigm shift in the way people interact with knowledge and information. A KBQA system aims to analyze a user's query to identify key entities, relationships and the type of information being sought, searches a knowledge base based on the understanding of the query (e.g., exploring connections between entities and relationships relevant to the question), and generates an answer based on selecting the most relevant information from the knowledge base and packaging it into a coherent and informative answer for the user.

While KBQA systems hold immense potential, they still face several challenges that hinder their performance. For example, they face issues regarding language understanding and ambiguity, transparency and low explainability, and sometimes hallucinate information that does not exist.

In addition, KBQA systems often rely on multiple large language models (LLMs) for entity linking and other subtasks which increases the latency of the process and reduces overall throughput. For example, natural language processing for the input query often involves computationally expensive training and retraining, which can slow performance. Also, entity linking presents challenges regarding ambiguity (e.g., multiple candidates and name variations that can lead to confusion), scalability (e.g., linking in large KBs needs efficient algorithms), and explainability (e.g., understanding how choices are made can be difficult, such as a block box effect). These types of KBQA systems are often constrained by high latency and low interpretability.

Accordingly, there is a need for fast and efficient retrieval of relevant information, improved reliability and resilience to errors and noise, and enhanced adaptability to various question types and knowledge bases. Also, there is a need for being able to perform entity detection and entity linking in one pass without any large language models (LLMs), robustness against query paraphrasing, and improved zero-shot linking tasks.

Further, there exists a need for better subtask performance and enhanced KBQA, which can answer questions faster, increase throughput, avoid hallucinations, improve entity disambiguation, and quickly and accurately perform various tasks for KBQA.

### SUMMARY OF THE DISCLOSURE

The present disclosure has been made in view of the above problems and it is an object of the present disclosure to provide a device and method that can provide fast and robust multi-purpose retrieval for knowledge base question and answering (KBQA), in the field of artificial intelligence (AI). Further, the method can quickly and accurately retrieve documents and efficiently perform related tasks for knowledge base question and answering, in the AI field.

Another object of the present disclosure is to provide a fast and robust multi-purpose retriever that can extract contextual information including entity nodes, answer nodes and numerical literals, for different KBQA sub-tasks such as entity linking, answer classification and constraint matching, and enable sub-graph reconstruction for Query Graph Generation (QGG) and Semantic Parsing (SP) based KBQA systems, which is notably robust against query paraphrasing and has improved zero-shot linking tasks.

An object of the present disclosure is to provide a retriever that can perform multi-purpose retrieval, retrieve correct paths from a knowledge base, provide improved zero-short performance that is better than LLM-based models, and be robust to paraphrasing.

Another object of the present disclosure is to provide a multi-purpose retriever that can efficiently capture key entities, answers and numerical literals from knowledge bases, empower diverse KBQA tasks from entity linking to constraint matching, and reconstruct sub-graphs for Information Retrieval (IR), Query Graph Generation (QGG) and Semantic Parsing (SP) systems.

An object of the present disclosure is to provide a method for controlling an artificial intelligence (AI) device that includes obtaining, via a processor in the AI device, a knowledge base including a plurality of nodes, flattening, via the processor, the knowledge base by transforming the knowledge base into a first plurality of documents to form a first index, each of the first plurality of documents identifying a node within the knowledge base, receiving, via the processor, a user query, retrieving, via the processor, a subset of documents based on the first plurality of documents and the user query, and performing, via the processor, a task related to knowledge base question answering (KBQA) based on the subset of documents.

Another object of the present disclosure is to provide method for controlling an artificial intelligence (AI) device in which the task related to knowledge base question answering (KBQA) includes at least one of answer generation, semantic parsing, and entity linking.

An object of the present disclosure is to provide a method in which the first plurality of documents are 1-hop documents, each of the first plurality of documents including at least three pieces of information corresponding to a node name, an in/outgoing link name, a name of other node.

Another object of the present disclosure is to provide a method for controlling an artificial intelligence (AI) device that includes augmenting the first index of the first plurality of documents by applying a label field to each of the first plurality of documents, in which each of the first plurality of documents includes at least four pieces of information corresponding to a node name, an in/outgoing link name, a name of other node, and the label field.

An object of the present disclosure is to provide a method in which the label field indicates at least one of a category, a topic, a person, a place, a thing, and an attribute.

Another object of the present disclosure is to provide a method for controlling an artificial intelligence (AI) device that includes performing matching based on the user query and the first plurality of documents to retrieve top K matching documents, where K is a positive integer, wherein the subset of documents is based on the top K matching documents.

Yet another object of the present disclosure is to provide a method for controlling an artificial intelligence (AI) device that includes creating a second index of a second plurality of documents based on Pseudo Relevance Feedback (PRF) by expanding the top K matching documents from the first index including the first plurality of documents, in which the second plurality of documents are 2-hop documents, each of the second plurality of documents including at least five pieces of information corresponding to a node name, an in/outgoing link name, a name of other node, an additional in/outgoing link name, and an additional name of another node.

An object of the present disclosure is to provide a method for controlling an artificial intelligence (AI) device that includes performing matching based on the user query and the second plurality of documents to retrieve top N matching documents, where N is a positive integer less than K, in which the subset of documents is based on the top N matching documents.

Another object of the present disclosure is to provide a method for controlling an artificial intelligence (AI) device that includes augmenting the second index of the second plurality of documents by applying a label field to each of the second plurality of documents, in which each of the second plurality of documents includes at least six pieces of information corresponding to a node name, an in/outgoing link name, a name of other node, an additional in/outgoing link name, an additional name of another node, and the label field.

An object of the present disclosure is to provide a method in which each document among the first plurality of documents includes a tuple having an entity name of a node within the knowledge base, a name of an incoming link or an outgoing link associated with the node.

Another object of the present disclosure is to provide a method in which the knowledge base includes at least one directed acyclic graph.

Yet another object of the present disclosure is to provide a method in which the subset of documents are determined without using any large language model (LLM).

An object of the present disclosure is to provide an artificial intelligence (AI) device that includes a memory configured to store knowledge base information, and a controller configured to obtain a knowledge base including a plurality of nodes, flatten the knowledge base by transforming the knowledge base into a first plurality of documents to form a first index, each of the first plurality of documents identifying a node within the knowledge base, receive a user query, retrieve a subset of documents based on the first plurality of documents and the user query, and execute a task related to knowledge base question answering (KBQA) based on the subset of documents.

Another object of the present disclosure is to provide a method for controlling an artificial intelligence (AI) device that includes obtaining, via a processor in the AI device, a knowledge base including a plurality of nodes, flattening, via the processor, the knowledge base by transforming the knowledge base into a first plurality of documents to form a first index, receiving, via the processor, a user query, retrieving, via the processor, a subset of documents based on the first plurality of documents and the user query, and outputting, via the processor, the subset of documents, in which the first plurality of documents are 1-hop documents, each of the first plurality of documents including at least three pieces of information corresponding to a node name, an in/outgoing link name, a name of other node.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example overall configuration of the AI device configured with a Knowledge base question and answering (KBQA) system according to an embodiment of the present disclosure.

FIG. 5 shows a flow chart of a method for controlling the AI device 100 according to an embodiment.

FIG. 6 shows an overview of components of the AI device for multi-purpose retrieval for knowledge base question and answering (KBQA), according to an embodiment of the present disclosure.

FIG. 7 of shows an example subgraph from a knowledge base, according to an embodiment of the present disclosure.

FIG. 8 shows an overview of components of the AI device for multi-purpose retrieval for knowledge base question and answering (KBQA) with two variations, according to an embodiment of the present disclosure.

FIG. 9 shows aspects of semantic parsing for KBQA, according to an embodiment of the present disclosure.

FIGS. 10A, 10B and 10C show aspects of entity linking for graph based KBQA, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

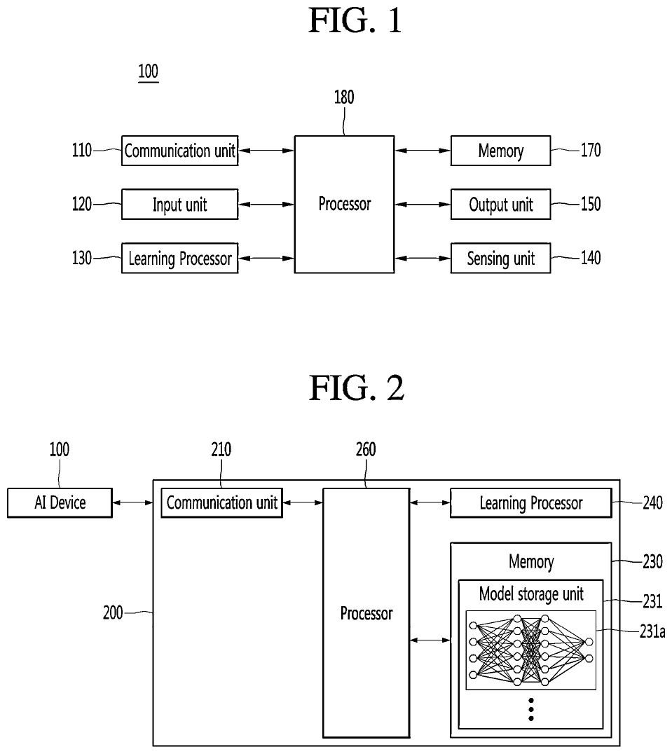

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

The communication unit 110 (e.g., communication interface or transceiver) can transmit and receive data to and from external devices such as other AI devices 100a to 100c and the AI server 200 by using wire/wireless communication technology. For example, the communication unit 110 can transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to an infer result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can execute knowledge base question and answer system, a recommender or a recommendation system. The recommender can recommend an item to a user or an action to pursue from available options or actions.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI apparatus 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server connected to an AI device 100 according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

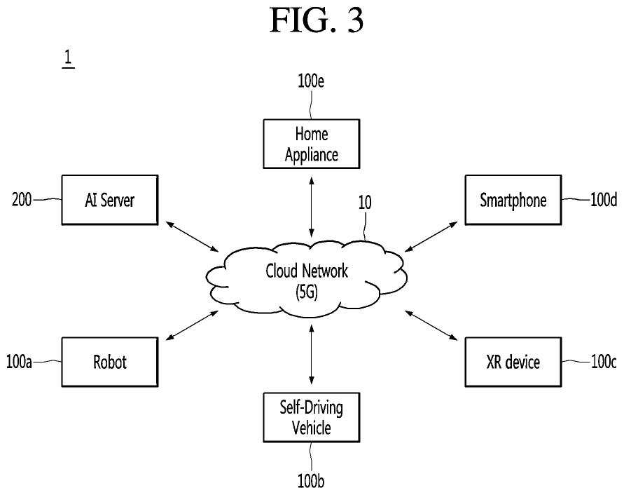

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, a multi-purpose retriever and KBQA system can be implemented as an application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system I can be connected to each other through the cloud network 10. In particular, each of the devices 100a to 100c and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

At this time, the AI server 200 can learn the artificial neural network according to the machine learning algorithm instead of the AI devices 100a to 100e, and can directly store the learning model or transmit the learning model to the AI devices 100a to 100e.

At this time, the AI server 200 can receive input data from the AI devices 100a to 100c, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement a multi-purpose retriever and KBQA system. The multi-purpose retriever and KBQA system or application can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can implement a multi-purpose retriever and KBQA system to respond to user queries.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation or generate an appropriate response.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. Also, the robot 100a can implement a multi-purpose retriever and KBQA system to respond to user queries or commands. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

Also, according to an embodiment, the robot 100a can be a cleaning robot that can execute a multi-purpose retriever and KBQA system to respond to user queries and/or commands.

According to another embodiment, the robot 100a can be a food preparation robot or a chef robot configured to automatically prep ingredients and prepare and cook a meal or food dish based on the multi-purpose retriever and KBQA system.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide answers to user's queries and traffic information including signal information and the like, such as a smart signal, to the self-driving vehicle 100b, and automatically connect an electric charger to a charging port by interacting with the self-driving vehicle 100b like an automatic electric charger of an electric vehicle.

Also, according to an embodiment, the self-driving vehicle 100b that can execute a KBQA system and perform entity linking to respond to user queries and commands.

According to an embodiment, the AI device 100 can implement a multi-purpose retriever and KBQA system or application that is configured to generate an answer in response to a user query or command.

According to another embodiment, the AI device 100 can be a multi-purpose retriever and KBQA system that is integrated into an infotainment system of the self-driving vehicle 100b, which can respond to user questions, but embodiments are not limited thereto. Also, the AI device 100 can be a multi-purpose retriever and KBQA system that is integrated into an infotainment system of the manual or human-driving vehicle.

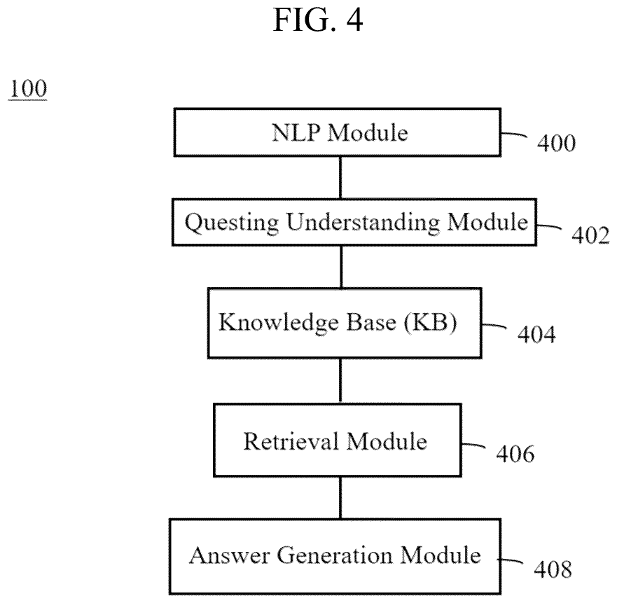

FIG. 4 shows an example overall configuration of the AI device 100 configured with a Knowledge base question and answering (KBQA) system according to an embodiment of the present disclosure. All the components of the KBQA system of the present disclosure are operatively coupled and configured.

Referring to FIG. 4, the AI device 100 can implement a KBQA system that has various components including a natural language processing (NLP) module 400, a question understanding module 402, a knowledge base (KB) 404, a retrieval module 406, and an answer generation module 408. Also, the parts of the KBQA system can be distributed among both of the AI device 100 and the AI server 200, but embodiments are not limited thereto. Alternatively, the entire KBQA system can be implemented within either of the AI device 100 or the AI server 200.

The natural language processing (NLP) module 400 can receive a user query and act as a language interpreter. The NLP module can perform tokenization and stemming to parse the user's query and identify key entities and relationships. Further, the NLP module can perform named entity recognition (NER) to identify entities, such as people, locations or organizations mentioned in the query and establish connections between pronouns and previously mentioned entities. However, embodiments are not limited thereto, and the NLP module can be replaced with a module that does not use any LLMs, as further detailed below.

For example, the NLP module 400 can use one or more large language modules (LLMs) to perform entity linking (e.g., BERT), in which topic entities mentioned in a question are detected and linked to the correct knowledge base identifiers. The NLP module can use a stack of transformer encoders and decoders that are pretrained on language tasks and can support fine tuning and reinforcement learning. Alternatively, the NLP module can use long short-term memory networks (LSTMs).

According to another embodiment, one or more of the NLP module 400, the question understanding module 402 and the retrieval module 406 can be replaced by a multi-purpose retriever that performs one or more tasks related to KBQA (e.g., entity linking, semantic parsing, etc.) and does not use any LLMs, discussed in more detail below, but embodiments arc not limited thereto. Also, according to an embodiment, a hybrid approach can be provided in which results generated by the NLP module can be combined with results generated by the multi-purpose retriever to create an aggregated list of knowledge base identifiers which can be provided to a deep learning based KBQA system for answering or responding to the user.

The question understanding module 402 can receive the processed query from the NLP module and analyze its structure and complexity. The question understanding module can determine the type of question being asked (e.g., factual, yes/no, comparative, etc.) and identifies the specific type of information the user is seeking, but embodiments are not limited thereto. For example, the question understanding module 402 can identify relationships between entities mentioned in the user's question and translate them into queries compatible with the knowledge base structure.

The knowledge base (KB) 404 is a repository that can contain a vast collection of interconnected facts and relationships about various entities. For example, the knowledge base 404 can be structured in different ways, e.g., triplets (e.g., subject-predicate-object), taxonomies, or ontologies. According to an embodiment, the KB can include triplets, in which each triplet can include a head, a relation and a tail. The knowledge base can support single hop paths, two hop paths or multiple N-hop paths, according to embodiments.

The knowledge base (KB) 404 can be a graph-based knowledge base (e.g., directed acyclic graphs DAGs) that can represent entities and relationships, and enable flexible connections and navigation, but embodiments are not limited thereto. For example, the KB can include Google Knowledge Graph and Freebase, etc.

The retrieval module 406 can bridge the gap between the interpreted query and the information stored in the knowledge base. For example, the retrieval module can translate the user's intent and entity mentions into queries compatible with the knowledge base structure, and perform a search within the knowledge base.

According to an embodiment, the retrieval module 406 can access specific entities, transverse relationship paths in the knowledge base, and/or employ reasoning techniques to gather relevant information.

The information gathered by the retrieval module 406 can be supplied to the answer generation module 408. The answer generation module can formulate a concise and informative response to the user query. For example, the answer generation module 408 can combine facts from different entities related to the query, summarize key points and filter out irrelevant information, and generate a natural language response that aligns with the type of the query and the user context, but embodiments are not limited thereto.

According to embodiments, elements of each of the natural language processing (NLP) module 400, the question understanding module 402, the knowledge base (KB) 404, the retrieval module 406, and the answer generation module 408 can be combined together into fewer modules, a single module and/or replaced with other types of modules. In addition, the natural language processing (NLP) module 400, the question understanding module 402, the knowledge base (KB) 404, the retrieval module 406, and the answer generation module 408 can be implemented as one or more controllers or by one or more processors, according to embodiments.

Aspects of the AI device 100 with respect to the multi-purpose retriever and related components are described in more detail below.

As discussed above, a Knowledge base question and answering (KBQA) system can rely on multiple large language modules (LLMs) for the task of entity linking (e.g., an NPL module, etc.). The task of entity linking involves detecting topic entities mentioned in the user question and linking them to the correct knowledge base identifiers. For example, this can be an initial step in the process of the KBQA. However, reliance on large language modules (LLMs) for the task of entity linking and other sub-tasks can present issues, such as increased latency, reduced overall throughput and can be computationally expensive. According to an embodiment, the use of multiple large language modules (LLMs) for the task of entity linking can be entirely replaced, as detailed below.

According to another embodiment, a hybrid approach can be provided in which results generated by the NLP module can be combined with results generated by a multi-purpose retriever that provides entity linking to create an aggregated list of knowledge base identifiers which can be provided to a KBQA system.

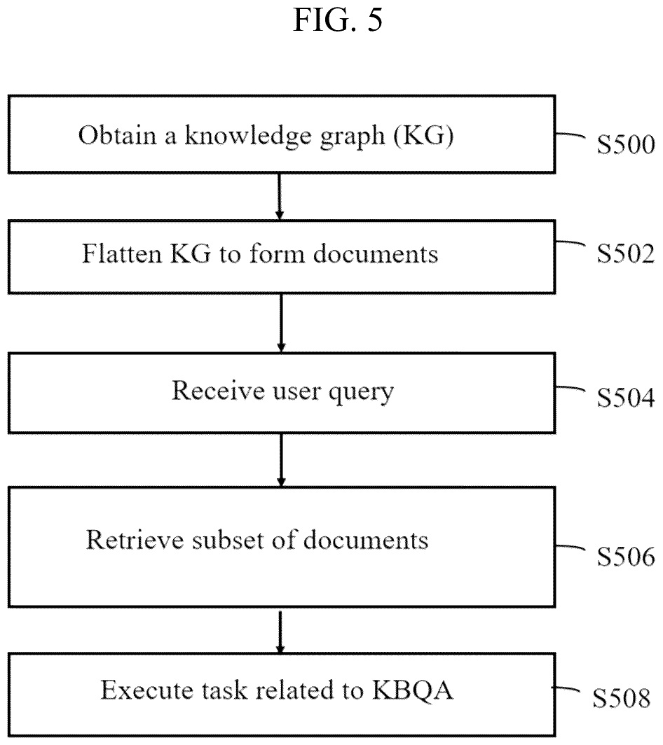

FIG. 5 shows a flow chart of a method for controlling the AI device 100 according to an embodiment.

Referring to FIG. 5, according to an embodiment, a method for controlling the AI device 100 can include obtaining, via a processor in the AI device 100, a knowledge base including a plurality of nodes (e.g., obtaining a knowledge graph (KG) in step S500). This method can further include flattening, via the processor, the knowledge base (knowledge graph KG) by transforming the knowledge base into a first plurality of documents to form a first index, where each of the first plurality of documents identifies a node within the knowledge base (e.g., step S502). The method can further include receiving, via the processor, a user query (e.g., step S504); retrieving, via the processor, a subset of documents based on the first plurality of documents and the user query (e.g., step S506), and performing, via the processor, a task related to knowledge base question answering (KBQA) based on the subset of documents (e.g., step S508).

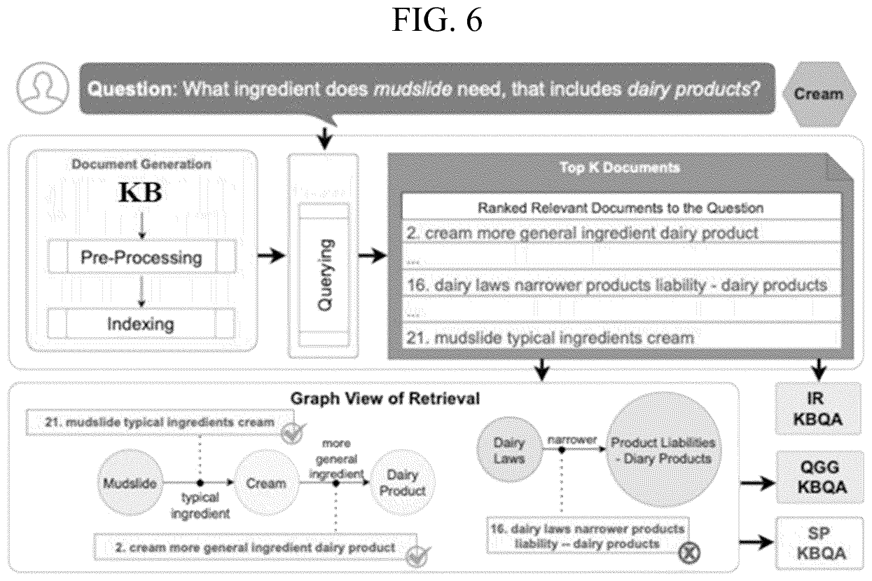

FIG. 6 shows an overview of components of a KBQA system in the AI device, according to an embodiment of the present disclosure. According to an embodiment, the entity linking task or method can be carried out by a multi-purpose retriever.

Referring to FIG. 6, according to an embodiment, the multi-purpose retriever can find relevant knowledge base information using a scoring method on a specially constructed index. Also, the multi-purpose retriever can use BM25 scoring over an index built by flattening knowledge base paths into documents, and can perform entity detection and linking in one pass without any large language models, but embodiments are not limited thereto.

For example, the multi-purpose retriever can obtain a knowledge base, and natural language labels for each of the knowledge base triplets can be concatenated to generate a corresponding document. Knowledge Bases can be represented using triplets: (e.g., head, relation, tail), where head and tail are entities or literals (e.g., numbers etc.). Freebase is an example of a knowledge base that can be used, but embodiments are not limited thereto.

According to an embodiment, the index can include 1-hop documents generated from the concatenation of natural language labels of each knowledge base triplet. For example, the triplet (:m.05n7nmg, :food.dish.ingredients, :m.01tv9) can be translated to “mudslide • typical ingredients • cream.” The index can include millions of 1-hop documents.

When the index is based on 1-hop documents, this design can be used for 1-hop questions in any KBQA dataset, where the topic entity and the answer entity exist in a 1-hop path. According to an embodiment, a Bag-of-Words retrieval can be used to retrieve answers. For example, the documents in the index can be viewed as bags holding word counters that can be compared to the user query using various measures such as cosine distance or Euclidean distance, with closer bags containing matching words and frequencies being the most relevant hits.

According to another embodiment, multi-hop documents can be used to improve precision and better handle more complex questions, as detailed below.

According to an embodiment, the multi-purpose retriever can be agnostic with regards to the type of backend KBQA system used. For example, the retrieved information and results can be passed to any type of KBQA system for answering the user, according to embodiments.

The AI device 100 including the multi-purpose retriever can flatten the knowledge base (KB) into a plurality of documents and can create a search index. For example, regarding a 1-hop document index, the flattening can include selecting a node within the knowledge base (KB) and extracting a name of the node, an incoming link of the node, an outgoing link of the node, and a KB identifier corresponding to the node, as well as a name or identifier for the second node on the other side of the link. For example, the KB identifier can be a hexadecimal code. Also, when creating the plurality of documents for the search index, the other meta data associated with the node can be ignored, but embodiments are not limited thereto.

In addition, each document among the plurality of documents can include a tuple that lists the natural language (English) names of the chosen node and a name of at least one link associated with the node (e.g., incoming link or outgoing link), and the name of the node at the other end of the incoming/outgoing link. This document creation process can be repeated for every node within the knowledge base (KB) to generate the plurality of documents.

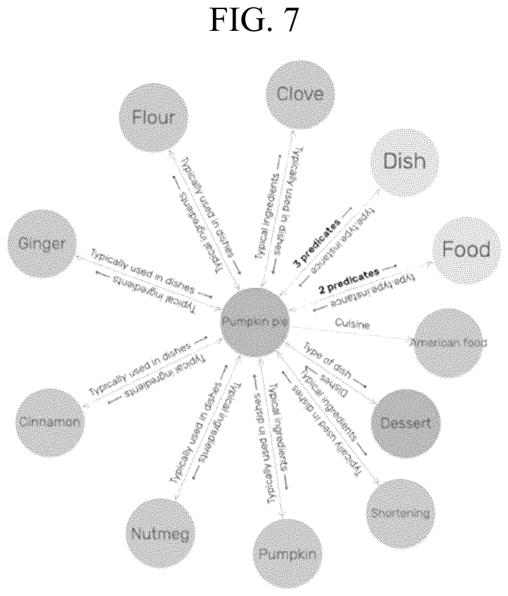

According to an embodiment, two documents can be created for each node within the knowledge base (KB), one document including a first tuple that includes the name of the node and the name of an incoming link associated with the node, and the name of the node at the other end of the incoming/outgoing link, and another document including a second tuple that includes the name of the node and the name of an outgoing link associated with the node, and the name of the node at the other end of the incoming/outgoing link, but embodiments are not limited thereto. For instance, the process can be applied to a knowledge base that includes multiple hop paths (e.g., three or more separate documents or tuples can be created for each node, etc.), which is discussed in more detail below. FIG. 7 shows an example subgraph, which is discussed in more detailed below.

With reference to FIG. 6, a querying pipeline is illustrated for performing one or more sub-tasks for a KBQA task (e.g., entity linking, semantic parsing, etc.). In this example, the knowledge base (KB) can include triplets (e.g., head, relation, tail), in which each triplet can represent a single hop path in the knowledge base (KB). Here, a food knowledge base is used as an example, but other types of knowledge base can be used.

With reference to FIG. 7, an example subgraph is shown for the entity of “Pumkin pie” and it highlights eleven KB triplets. An example of a named triplet in FIG. 7 is (Pumpkin pie, typical ingredients, clove).

Further in this example, the AI device 100 including the multi-purpose retriever can flatten the knowledge base (KB) by creating documents using tuples made from the triplets. For example, from a triplet (head, relation, tail), two documents can be created, such as a first document for (head, relation, tail) portion of the triplet, e.g., (Pumkin pic, typical ingredients, clove) and a second document for (relation, tail) portion of the triplet, e.g., (clove, typically used in dish, Pumpkin pie).

According to an embodiment, the document can be created using concatenation of the tuple labels, in which this process can be repeated for all of the nodes within the knowledge base to create a plurality of documents. Also, each document can contain the corresponding knowledge base identifier (e.g., a hexadecimal code). Then these documents can be pre-processed to be indexed for creating the search index using all of the tuple documents. The search index can be created based on pyserini or elastic search, but embodiments are not limited thereto.

In addition, a search procedure, such as BM25, can be used on the search index to retrieve the best matching top K documents, which can be ranked based on several factors including term frequency (TF), document length (DL), inverse document frequency (IDF), and tunable parameters for controlling the impact of term frequency (TF) and inverse document frequency (IDF), but embodiments are not limited thereto. For example, various equations and variants can be used for scoring ranked results depending on design parameters and needs.

As shown in FIG. 6, after generating the ranked results including the top K documents that match the user input query, the result can be transmitted to a KBQA system (e.g., an Information Retrieval (IR) KBQA, a Query Graph Generation (QGG) KBQA, and/or a Semantic Parsing (SP) KBQA). According to another embodiment, the top K documents can be used for setting entities, in which the entities and their corresponding knowledge base identifiers can be directly passed to the KBQA system for answering the user's query.

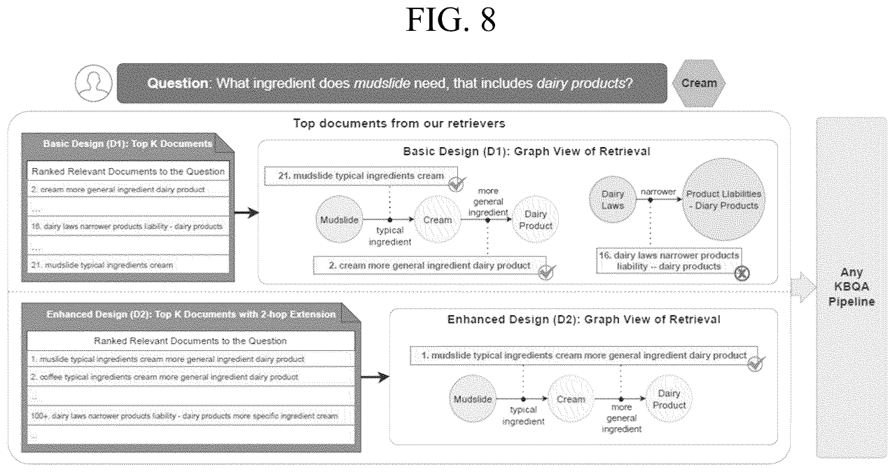

According to another embodiment, with reference to FIG. 8, the AI device 100 including the multi-purpose retriever can flatten the knowledge base (KB) into a plurality of documents that includes 2-hop documents. FIG. 8 shows side by side example embodiments of using an index of 1-hop documents (discussed above with regards to FIG. 6) and an index of 2-hop documents.

For example, an index of 1-hop documents can be suitable for answering simple, 1-hop questions where the topic entity and the answer entity exist in a 1-hop path. However, this type of implementation can have lower precision for multi-entity or multi-hop based complex questions.

With reference to FIG. 8, a multi-entity question has multiple topic entities contributing towards reasoning. For example, in the user query “what ingredient does mudslide need, that includes dairy products?,” the topic entities “mudslide” and “dairy product” should be given similar weights, but the correct dairy product document is ranked at the 2nd position, while the correct mudslide document is at the 21st position when using the index of 1-hop documents. Such noisy retrieval can increase the difficultly of downstream reasoning as it needs to choose both these documents to answer the question.

In addition, a multi-hop question can involve traveling multiple hops in a knowledge base. For example, a shorter of the question in FIG. 8, “which cocktails contain dairy products?” needs two hops to answer, e.g., the first hop finds “dairy products” and the second hop detects “cocktails” that use these “dairy products.” It is evident that the output of the first hop (e.g., cream) is not present in the question. Since this design (e.g., D1) can use a Bag-of-Words (BoW) retrieval, it only retrieves 1-hop documents with words presented in the question, causing it to miss the answer.

These issues faced by using the index of 1-hop documents (e.g., design D1) can be addressed with an enhanced multi-entity and multi-hop design (e.g., design D2).

Also, another issue is that a knowledgebase may have too many 2-hop paths. For example, a knowledge base may include as many as 10 million nodes and the creation of the first index of 1-hop documents for this knowledge base can similarly include about 10 million documents, but creating all 2-hop documents directly from the knowledge base may end up requiring creating over 1 trillion documents. For instance, there are over 1 trillion 2-hop paths in Freebase, which can make creating a corpus of all 2-hop documents impractical and too resource intensive.

According to an embodiment, Pseudo Relevance Feedback (PRF) principles can be leveraged to reduce the size of the corpus of documents when creating the second index of 2-hop documents.

For example, the multi-purpose retriever can retrieve a first set of ranked documents based on the user query, in which this first set can be used as forming the initial feedback set. Then, the multi-purpose retriever can extract key terms and phrases from the top-ranked documents, identifying those that are frequently used and potentially relevant to the user's information need (e.g., term frequency, inverse document frequency IDF, or other statistical measures can be used to weigh terms). Further, the multi-purpose retriever can expand the query added the extracted key terms and phrases to the original query, in order to expand its scope and capture additional relevant concepts and items. Then, the multi-purpose retriever can use the expanded query to re-rank documents, which can boost results that contain the newly added extracted terms and better align with the user's intent.

In this situation, a 2-hop corpus creation can be conditioned on retrieved 1-hop results (Pseudo Relevant documents) from the previous first index of 1-hop documents, discussed above. In this way, the multi-purpose retriever retrieves the relevant multi-entity, multi-hop document at rank 1 and improves aforementioned lower precision problems (e.g., enhanced D2 in FIG. 8). This approach can also be extended beyond 2-hop to n-hop documents, where n is a number greater than 2.

For example, the corpus of 1-hop documents can be created as discussed above, then the multi-purpose retriever uses the user query to retrieve the top K matching documents from the first index of 1-hop documents. K can be a number in a range of 10 to 100, but embodiments are not limited thereto.

Then, the multi-purpose retriever can expand the top K matching documents from the first index of 1-hop documents to create a second index of 2-hop documents. Also, each document in the first index of 1-hop documents can include three pieces of information, e.g., a node name, in/outgoing link name, and a name of other node (e.g., 1-hop). In addition, each document in the second index of 2-hop documents can include five pieces of information, e.g., a node name, in/outgoing link name, name of other node, an additional in/outgoing link name, and an additional name of another node (e.g., 2-hops). However, embodiments are not limited thereto and additional information can further be included in the first index and second index (e.g., meta data and IDs for each node can be included, etc.).

Using the second index of 2-hop documents, the multi-purpose retriever can retrieve the top N matching documents. Here, N is much less than K, e.g., N can be a number in a range of 1-3, but embodiments are not limited thereto. In this situation, the multi-purpose retriever returns the best 2-hop documents that match the user query (e.g., the top N matching documents).

In other words, rather than creating a corpus of all 2-hop documents directly from the knowledge base (e.g., which could result in trillions of documents), the multi-purpose retriever can create the second index of 2-hop documents based on the top K matching documents from the first index of 1-hop documents. In this way, the number of 2-hop documents used for the second index can be drastically reduced and refined to include more relevant information.

In this situation, the first index of 1-hop documents can be created once before receiving any user query (e.g., the first index of 1-hop documents is created one time at the outset). However, the second index of 2-hop documents can be created dynamically “on-the-fly” for each separate user inquiry. In other words, the second index of 2-hop documents can be uniquely created for the current user query and can be different every time for subsequent user queries.

According to another embodiment, an add-on feature for entity disambiguation can be provided, which can be applied to both of the multi-purpose retriever using the first index of 1-hop documents and the multi-purpose retriever using second index of 2-hop documents.

In addition, the embodiments discussed above regarding the multi-purpose retriever can be further augmented with a type of “add-on” design, which can be applied to either of the 1-hop implementation and the 2-hop implementation.

For example, a sub-entity matching issue can occur in sparse retrieval. For instance, a query about “dairy product” would match documents containing “dairy” or “product.” Sometimes, a high frequency of these matches can cause topic shift. For example, the results span topics from “dairy products” to “dairy production laws” or “product manufacturing.” Also, topic shift can become even worse for an implementation using the second index of 2-hop documents, whose performance depends on the quality of the first index of 1-hop documents.

In order to address the above issue, a field search can be applied as an add-on design for the multi-hop implementation and the single-hop implementation. For example, the documents in the index can be augmented with explicit entity label fields. In this way, a query can be further matched against each of the label fields in addition to the document, leading to better linking performance.

In other words, an additional label field can be added to each document in the corpus. For example, for the document “mudslide • typical ingredients • cream” two new field can be added, e.g., head1:mudslide and tail1:cream. According to another example, the additional label field added to each document in the corpus can correspond to a category or topic (e.g., food, person, place, animal, plant, etc.).

In this way, entity disambiguation can be better addressed. For example, if the user query involves the actress “America Ferrara” from the shows Ugly Betty and Superstore, then the multi-purpose retriever can use the label field to filter and match results related to the person or people that have the name “America” rather than results that are related to “America” the country.

According to an embodiment, the additional label field can be added to each document in the first index. For example, the first index of 1-hop documents can include four pieces of information, e.g., a node name, in/outgoing link name, a name of other node, and the label field.

According to another embodiment, the additional label field can be added to each document in the second index. For example, each document in the second index of 2-hop documents can include six pieces of information, e.g., a node name, in/outgoing link name, name of other node, an additional in/outgoing link name, an additional name of another node, and the label field.

According to embodiments, the results retrieved by the multi-purpose retriever can be used for various tasks for KQBA, such as multi-purpose reasoning over retrieved documents that can include answer generation through machine reading comprehension (MRC), semantic parsing, and entity linking for KBQA graph approaches, but embodiments are not limited thereto.

Regarding answer generation through machine reading comprehension (MRC), the AI device 100 including the multi-purpose retriever can convert the top documents returned based on the user query into a paragraph by concatenating all the top documents. Then a pre-trained/fined-tuned MRC model can receive the user query and the created paragraph as inputs for generating an answer.

For example, the AI device 100 including the multi-purpose retriever can receive a user query of “What ingredient does mudslide need, that includes dairy products?” and can generate the below example paragraph from the top 10 retrieved documents.
milk more general ingredient dairy product
cream more general ingredient dairy product
butter more general ingredient dairy product
dairy product more specific ingredient cream
dairy product more specific ingredient milk
products liability—dairy products preferred label products liability—dairy products
products liability—dairy products alternate label dairy products—products liability
used in products short description products that include this ingredient.
mudslide typical ingredients cream
mudslide typical ingredients kahlúa

### [Example of Concatenated Paragraph]

Then, the concatenated paragraph and the user query can be input into the MRC model and based on these inputs the MRC model can output an answer (e.g., “cream”).

According to another embodiment, the results retrieved by the multi-purpose retriever can be used for sematic parsing, which can generate logic/form expression to query the original knowledge base to generate an answer.

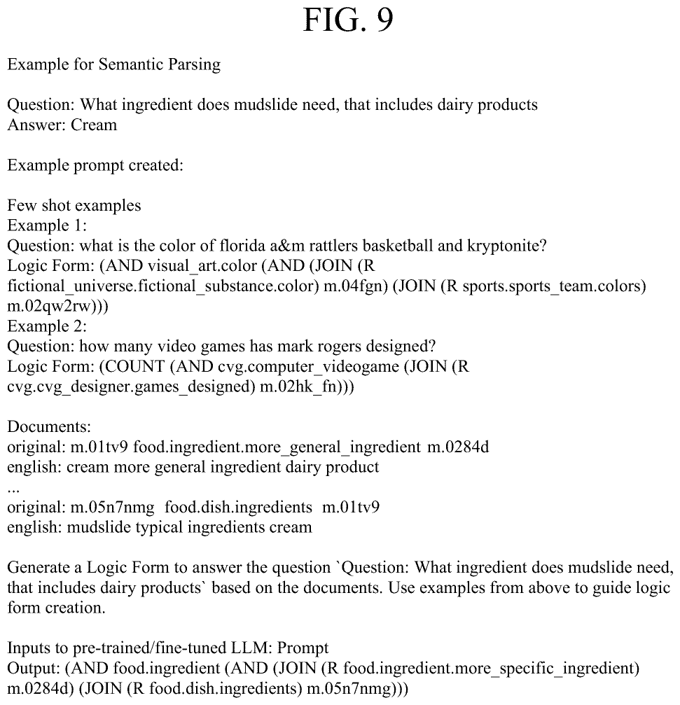

For example, with reference to FIG. 9, the AI device 100 can create a prompt for a pretrained LLM with the retrieved documents, the user query, and few shot examples. This can include choosing training examples that are most relevant to the user's question and their logic form/set expression annotations, and combining few shot questions, logic form annotation pairs, the user's question, and the retrieved ranked documents to generate the prompt.

Then, the AI device 100 can use a pre-trained/fine-tuned LLM to generate logic form/set expression, and used heuristic code to convert the logic form/set expression into a (SPARQL) query (e.g., which is specifically designed to interact with knowledge bases to bridge the gap between natural language and structured data retrieval). Then, the AI device 100 can execute the SPARQL query using a system (e.g., Virtuoso, etc.) to extract answers from the original knowledge base. In this way, the AI device 100 can extract the relevant answers based on the structured query, effectively retrieving information from the knowledge base in a precise and meaningful way.

According to another embodiment, the results retrieved by the multi-purpose retriever can be used for entity linking for KBQA graph approaches. For example, the AI device 100 can include or communicate with a graph based KBQA system that uses a small sub-graph to begin a graph walk until the answer is obtained.

For example, the AI device 100 can execute a method that includes converting retrieved documents back into knowledge base sub-graphs. For example, the AI device 100 configured with the multi-purpose retriever can choose top M sub-graphs and run graph based KBQA approaches on these top M sub-graphs to answer the user query (where M is a positive number).

According to an embodiment, the choosing the top M sub-graphs can include identifying unique connected sub-graphs from the ranked document results returned by the multi-purpose retriever, generating a score for each unique sub-graph based on the document scores (e.g., choose maximum score, or sum of all scores, etc.), and choosing the top M results (e.g., the top 1 or 2 results). Then, the AI device 100 can run graph based KBQA approaches over these top M subgraphs to answer the question. For example, these top M sub-graphs are expected to contain the correct topic entity, e.g., should be considered as the output of entity linking step.

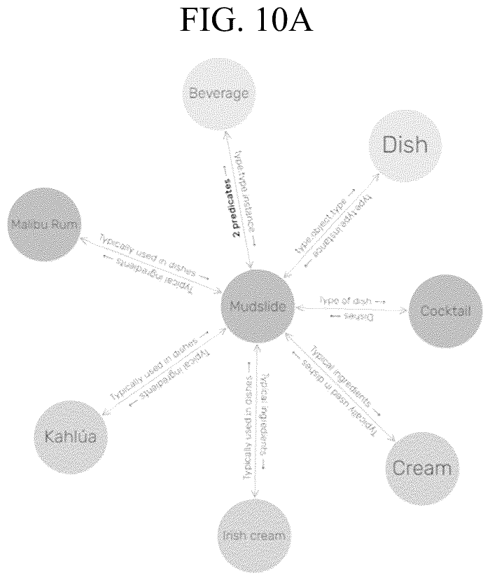

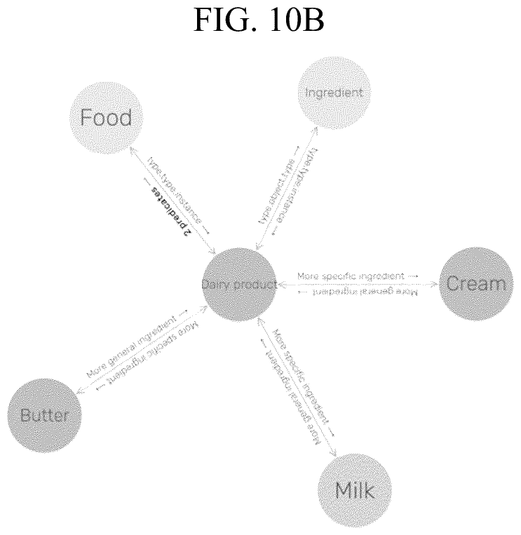

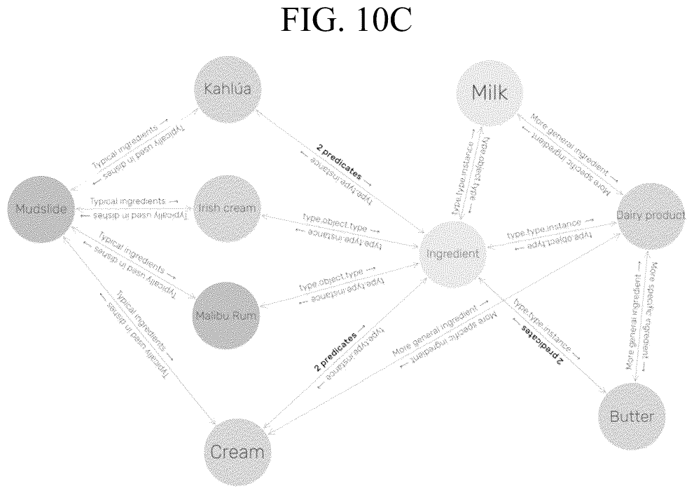

For example, as shown in FIGS. 10A-10C, two sub-graphs can be generated based on the ranked document results returned by the multi-purpose retriever which can be used to create a connected sub-graph. For example, based on a user query “What ingredient does mudslide need, that includes dairy products?,” the first sub-graph shown in FIG. 10A can be created based on focusing on the entity “mudslide.” Also, the second sub-graph shown in FIG. 10B can be created based on focusing on the entity “dairy product.”

Further, as shown in FIG. 10C, a connected sub-graph can be created based on the two sub-graphs. Then, the AI device 100 can use the connected sub-graph to extract the answer “cream” through a graph walk, in response to the user query “What ingredient does mudslide need, that includes dairy products?”

For example, the connected sub-graph includes entities (e.g., nodes) and relations (e.g., links between nodes). To answer the user query, a walking path can start at a node identified through entity linking, then paths can be chosen based on the goal or query, gathering information from each entity and link. By navigating this information web, the AI device 100 can eventually reach the destination, e.g., “cream”—the answer hidden within the network of connections.

The above designs were tested with Recall and MAP using the GrailQA dev split dataset with 6763 QA pairs for experiments in comparison to RnG and ReTraCK pipelines with regards to topic entity linking and answer linking components. For example, Recal and MAP are metrics used to evaluate the performance of retrieval systems, including systems focused on knowledge based question answering (KBQA). Rank-and-Generate (RnG) and Retriever-Transducer-Checker (ReTraCK) are trained on GrailQA and their checkpoints are open-sourced, and serve as quality approaches for question answering over knowledge bases for evaluation.

As shown in Table I and Table 2 below, results from each of the embodiment using the first index of 1-hop documents (e.g., D1), the embodiment using the first index of 1-hop documents plus the additional label field (e.g., D1+D3), the embodiment using the second index of 2-hop documents with Pseudo Relevance Feedback (PRF) (e.g., D2), and the embodiment using the second index of 2-hop documents with Pseudo Relevance Feedback (PRF) documents plus the additional label field (e.g., D2+D3) are compared with results from RnG and ReTraCK pipelines with regards to topic entity linking and answer linking components.

In addition, the embodiment using the first index of 1-hop documents (e.g., D1) and the embodiment using the first index of 1-hop documents plus the additional label field (e.g., D1+D3) were created with KB information only and are completely independent of the KBQA dataset. Hence, all of the D1 and D1+D3 results reflect zero-shot performance. Also, the choice of k reflects the difficultly faced by sparse retrieval and the designs detailed above. Greater k values are chosen for challenging tasks. Values from {3, 10, 100} are chosen to indicate the smallest k, where various embodiments are shown to improve performance.

TABLE 1
Topic Entity Retrieval
(@ k = 10)

| Model | Recall | MAP |
|---|---|---|
| RnG | 80.7 | — |
| ReTraCk | 76.4 | — |
| D1 @10 | 83.19 | 71.78 |
| D1 + D3 @10 | 84.21 | 74.24 |
| D2 @10 | 82.86 | 75.74 |
| D2 + D3 @10 | 83.27 | 76.05 |

TABLE 2
Answer Retrieval (@ k = 100)

| | Overall | | 1-hop only | | 2-hop only | |
|---|---|---|---|---|---|---|
| Model | Recall | MAP | Recall | MAP | Recall | MAP |
| RnG | 77.77 | — | 84.04 | — | 77.53 | — |
| ReTraCk | 69.55 | — | 72.86 | — | 60.95 | — |
| D1 @100 | 71.02 | 38.29 | 85.49 | 50.66 | 44.59 | 13.06 |
| D1 + D3 @100 | 74.20 | 40.86 | 85.49 | 51.39 | 44.59 | 11.87 |
| D2 @100 | 66.82 | 44.74 | 74.86 | 54.54 | 59.36 | 30.20 |
| D2 + D3 @100 | 70.16 | 44.10 | 74.86 | 50.74 | 59.36 | 26.14 |

As shown above, various embodiments of the present disclosure show improve results regarding topic retrieval and answer retrieval.

For instance, regarding topic entity retrieval, Table 1 shows that embodiments of the present disclosure exceed RnG's recall with an absolute gain of over 3.5% at k=10. The embodiment using the first index of 1-hop documents (e.g., D1) also obtains 11% gains at k=100. Also, the embodiment including additional label field (e.g., D3) shows that both MAP and recall are improved.

In addition, regarding answer retrieval, Table 2 shows that embodiments of the present disclosure have competitive performance at k=100 while often using less resources and lower latency. D1 variants and D2+D3 outperform ReTraCk for the overall setting. Also, the embodiment using the first index of 1-hop documents (e.g., D1) 1-hop outperforms other models, hence reinforcing its compatibility for answering simple (1-hop) questions.

Also, embodiments of the present disclosure achieve great (node level) performance. For evaluation testing, a new triplet evaluation dataset for GrailQA was used to benchmark their triplet (e.g., KB path) retrieval. This evaluation dataset is created using SPARQL queries, which have triplet structures as below.
SELECT DISTINCT ?x0 WHERE
VALUES ?x2 {: m.064dsyn}
?x0:exhibitions.exhibition.curators ?x1
?x2:exhibitions.exhibition.curators ?x1

### [Triplet Structures]

Further, SPARQL queries are modified to return the entity IDs for all of the variables (?x0, etc.), which are then replaced with matching entity IDs to create triplets for evaluation2. This evaluation dataset aids in comprehensive evaluation of overall multi-purpose retrieval quality and can be constructed based on any KBQA dataset with SPARQL query annotations.

In Table 4 below, the recall values at k=10 indicate that embodiments of the present disclosure are multi-purpose and can extract the correct KB paths. The combination of high topic and answer linking abilities allows the 1-hop (D1) index embodiment to obtain the highest recall of 76% at k=100.

TABLE 3
Zero-Shot Results
(@k = 3)

| Dataset | GQA | FBQA | CWQ |
|---|---|---|---|
| Size | 3656 | 3996 | 3519 |
| Model ↓ | Recall | | |
| RnG | 77.90 | 35.67 | 49.33 |
| ReTraCk | 71.10 | 32.62 | 40.26 |
| D1@3 | 77.04 | 30.80 | 43.18 |
| D1 + D3@3 | 78.11 | 38.23 | 47.89 |
| D2@3 | 82.23 | 35.82 | 43.78 |
| D2 + D3@3 | 83.70 | 43.65 | 50.25 |

TABLE 4
Triplet Numbers
(@k = 10)

| Model | Recall | MAP |
|---|---|---|
| D1@10 | 64.59 | 52.14 |
| D2@10 | 64.80 | 60.13 |
| D1 + D3@10 | 62.87 | 51.87 |
| D2 + D3@10 | 63.09 | 56.25 |

TABLE 5
Impact of Entity
Paraphrasing on Linking

| | Recall | | |
|---|---|---|---|
| Model | Org. | Para. | Exp. |
| RnG | 76.10 | 69.96 | — |
| ReTrack | 66.21 | 60.56 | — |
| D1@10 | 88.31 | 38.04 | 87.14 |
| D2@10 | 87.62 | 60.01 | 75.83 |

In addition, experiments were carried out to test the zero-short performance of embodiments of the present disclosure, which were better than LLM-based models. For instance, the GrailQA dev set's zero-shot subset (GQA), FreebaseQA (FBQA) and Complex WebQuestions (CWQ) were used to evaluate the zero-shot abilities of all models. Also, RnG uses WebQSP for training, and can have higher performance for Complex Web Questions which is built using WebQSP. Table 3 above shows that embodiments of the present disclosure outperform RnG and ReTraCk on all datasets at k=3, with the embodiment using the second index of 2-hop documents with Pseudo Relevance Feedback (PRF) documents plus the additional label field (e.g., D2+D3) exceeds the best models by 7.98% on FBQA and by 5.8% on GrailQA. The embodiment using 1-hop plus the additional label field (e.g., D1+D3) has an absolute recall gain of 18.80% on FBQA and 11.03% on CWQ at k=10.

Also, embodiments of the present disclosure are robust to paraphrasing. Experiments were carried out evaluate query paraphrasing robustness of the models against topic entity paraphrasing. Paraphrased questions are generated by replacing topic entities with their synonyms or alternative names. For instance, “gram per cubic centimetre” entity in a question is changed to “g/cc.” This method was used to paraphrase a random sub-sample of 500 questions from GrailQA and run all the entity linking components on it. When a question has multiple paraphrases, the performance was averaged.

Table 5 above shows that all the systems register a drop in performance. However, when using IR technique of query expansion, retrievers according to embodiments of the present disclosure recover to a great extent. Also, the low latency of the multi-purpose retriever according to embodiments of the present disclosure allow for the ability to employ techniques like query expansion.

Thus, as shown by the experiment results above, embodiments of the present disclosure provide improvements over the existing technology regarding KBQA.

According to one or more embodiments of the present disclosure, the AI device 100 implementing the multi-purpose retriever for KBQA can provide fast and efficient retrieval of relevant information, improved reliability and resilience to errors and noise, and enhanced adaptability to various question types and knowledge bases.

Also, the AI device 100 implementing the multi-purpose retriever for KBQA can improve subtask performance, increase throughput, avoid hallucinations, improve entity disambiguation, and perform entity detection and entity linking in one pass without any large language models (LLMs).

According to one or more embodiments of the present disclosure, the AI device 100 implementing the multi-purpose retriever for KBQA can be robust against query paraphrasing, and improved zero-shot linking tasks.

According to one or more embodiments of the present disclosure, the AI device 100 implementing the multi-purpose retriever for KBQA can solve one or more technological problems in the existing technology, such as providing improved performance, increased throughput, and more quickly and accurately performing entity linking. Also, the AI device 100 implementing the multi-purpose retriever for KBQA can help avoid or prevent hallucinations, since reliance on large language models (LLMs) and natural language processing (NPL) modules can be reduced or avoided with regards to the entity linking task.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, a knowledge base including a plurality of nodes;
flattening, via the processor, the knowledge base by transforming the knowledge base into a first plurality of documents to form a first index, each of the first plurality of documents identifying a node within the knowledge base;
receiving, via the processor, a user query;
retrieving, via the processor, a subset of documents based on the first plurality of documents and the user query; and
performing, via the processor, a task related to knowledge base question answering (KBQA) based on the subset of documents.

2. The method of claim 1, wherein the task includes at least one of answer generation, semantic parsing, and entity linking.

3. The method of claim 1, wherein the first plurality of documents are 1-hop documents, each of the first plurality of documents including at least three pieces of information corresponding to a node name, an in/outgoing link name, and a name of other node.

4. The method of claim 1, further comprising:
augmenting the first index of the first plurality of documents by applying a label field to each of the first plurality of documents,
wherein each of the first plurality of documents includes at least four pieces of information corresponding to a node name, an in/outgoing link name, a name of other node, and the label field.

5. The method of claim 4, wherein the label field indicates at least one of a category, a topic, a person, a place, a thing, and an attribute.

6. The method of claim 1, wherein the retrieving includes:
performing matching based on the user query and the first plurality of documents to retrieve top K matching documents, where K is a positive integer,
wherein the subset of documents is based on the top K matching documents.

7. The method of claim 6, wherein the retrieving further includes:
creating a second index of a second plurality of documents based on Pseudo Relevance Feedback (PRF) by expanding the top K matching documents from the first index including the first plurality of documents,
wherein the second plurality of documents are 2-hop documents, each of the second plurality of documents including at least five pieces of information corresponding to a node name, an in/outgoing link name, a name of other node, an additional in/outgoing link name, and an additional name of another node.

8. The method of claim 7, wherein the retrieving further includes:
performing matching based on the user query and the second plurality of documents to retrieve top N matching documents, where N is a positive integer less than K,
wherein the subset of documents is based on the top N matching documents.

9. The method of claim 7, further comprising:
augmenting the second index of the second plurality of documents by applying a label field to each of the second plurality of documents,
wherein each of the second plurality of documents includes at least six pieces of information corresponding to a node name, an in/outgoing link name, a name of other node, an additional in/outgoing link name, an additional name of another node, and the label field.

10. The method of claim 1, wherein each document among the first plurality of documents includes a tuple having an entity name of a node within the knowledge base, a name of an incoming link or an outgoing link associated with the node.

11. The method of claim 1, wherein the knowledge base includes at least one directed acyclic graph.

12. The method of claim 1, wherein the subset of documents are determined without using any large language model (LLM).

13. An artificial intelligence (AI) device for entity linking, the AI device comprising:
a memory configured to store knowledge base information; and
a controller configured to:
obtain a knowledge base including a plurality of nodes,
flatten the knowledge base by transforming the knowledge base into a first plurality of documents to form a first index, each of the first plurality of documents identifying a node within the knowledge base,
receive a user query,
retrieve a subset of documents based on the first plurality of documents and the user query, and
execute a task related to knowledge base question answering (KBQA) based on the subset of documents.

14. The AI device of claim 13, wherein the task includes at least one of answer generation, semantic parsing, and entity linking.

15. The AI device of claim 13, wherein the controller is further configured to:
augment the first index of the first plurality of documents by applying a label field to each of the first plurality of documents,
wherein each of the first plurality of documents includes at least four pieces of information corresponding to a node name, an in/outgoing link name, a name of other node, and the label field.

16. The AI device of claim 13, wherein the controller is further configured to:
perform matching based on the user query and the first plurality of documents to retrieve top K matching documents, where K is a positive integer,
wherein the subset of documents is based on the top K matching documents.

17. The AI device of claim 16, wherein the controller is further configured to:
create a second index of a second plurality of documents based on Pseudo Relevance Feedback (PRF) by expanding the top K matching documents from the first index including the first plurality of documents,
wherein the second plurality of documents are 2-hop documents, each of the second plurality of documents including at least five pieces of information corresponding to a node name, an in/outgoing link name, a name of other node, an additional in/outgoing link name, and an additional name of another node.

18. The AI device of claim 17, wherein the controller is further configured to:
perform matching based on the user query and the second plurality of documents to retrieve top N matching documents, where N is a positive integer less than K,
wherein the subset of documents is based on the top N matching documents.

19. The AI device of claim 17, wherein the controller is further configured to:
augment the second index of the second plurality of documents by applying a label field to each of the second plurality of documents,
wherein each of the second plurality of documents includes at least six pieces of information corresponding to a node name, an in/outgoing link name, a name of other node, an additional in/outgoing link name, an additional name of another node, and the label field.

20. A method for controlling an artificial intelligence (AI) device, the method comprising:
obtaining, via a processor in the AI device, a knowledge base including a plurality of nodes;
flattening, via the processor, the knowledge base by transforming the knowledge base into a first plurality of documents to form a first index;
receiving, via the processor, a user query;
retrieving, via the processor, a subset of documents based on the first plurality of documents and the user query; and
outputting, via the processor, the subset of documents,
wherein the first plurality of documents are 1-hop documents, each of the first plurality of documents including at least three pieces of information corresponding to a node name, an in/outgoing link name, a name of other node.
